(19) United States
(12) Patent Application Publication
(10) Pub. No.: US 2005/0163438 A1
(43) Pub. Date: Jul. 28, 2005

(54) Integrated semiconductor optical device, method and apparatus for manufacturing such a device

(76) Inventors: Aloysius Franciscus Maria Sander, Eindhoven (NL); Gerardus Maria Dohmen, Eindhoven (NL); Edwin Maria Wolterink, Eindhoven (NL)

Correspondence Address: PHILIPS INTELLECTUAL PROPERTY & STANDARDS, P.O. BOX 3001, BRIARCLIFF MANOR, NY, 10510, US

(21) Appl. No.: 10/504,243

(22) PCT Filed: Jan. 27, 2003
(86) PCT No.: PCT/IB03/00226

(30) Foreign Application Priority Data
Feb. 13, 2002 (EP) 02075587.2

(51) Int. Cl. G02B 6/36

(52) U.S. Cl. 385/92; 385/93

(57) ABSTRACT

The invention relates to an integrated semiconductor optical device comprising: a) an optical element (2), b) a housing (3) around said optical element (2), c) a glass window (51, 52) in said housing (3) allowing a light beam (71, 72) to pass through. In order to integrate the optics and the semiconductor optical device, while avoiding a difficult alignment procedure when using discrete lenses, the integrated semiconductor optical device according to the present invention further comprises a lens (61, 62) associated with said glass window (51, 52), said lens (61, 62) being directly replicated on the surface of said glass window (51, 52) outside said housing (3) by means of a replication method comprising the steps of: 1) filling a gap between the glass window and a mould with a liquid light-transmissive polymeric material, 2) curing the polymeric material to obtain said lens, and 3) removing the mould.

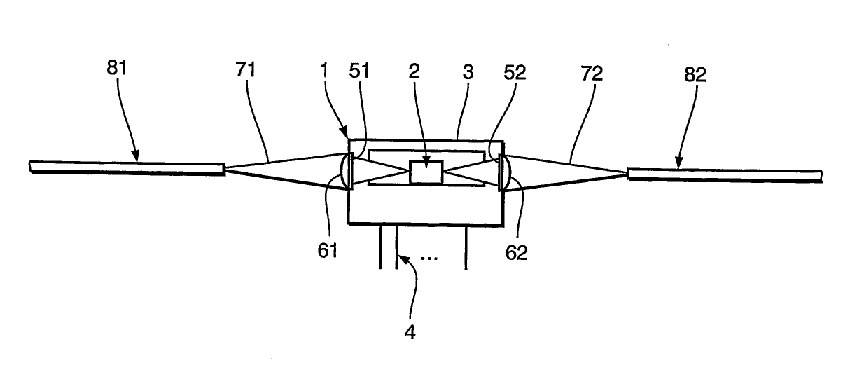

The invention relates to an integrated semiconductor optical device comprising an optical element, a housing around said optical element and a glass window in said housing allowing a light beam to pass through. The invention also relates to a method of manufacturing an integrated semiconductor optical device as well as to a corresponding apparatus for manufacturing such a device.

In a semiconductor optical amplifier (SOA), light from a fibre must be coupled into the amplifier for its amplification. It must then be coupled into a fibre again. Usually, discrete standard lenses or customized lenses are used for this coupling. Such lenses are relatively large, and the alignment procedure is difficult and laborious.

It is therefore an object of the present invention to provide a semiconductor optical device as well as a method and an apparatus for manufacturing such a device, which can be integrated and by which the problems described above can be avoided.

According to the present invention, this object is achieved by an integrated semiconductor optical device as defined in claim 1 which, in addition to the optical element, the housing and the glass window as mentioned above, further comprises a lens associated with said glass window, said lens being directly replicated on the surface of said glass window outside said housing by means of a replication method comprising the steps of:
filling a gap between the glass window and a mould with a liquid light-transmissive polymeric material,
curing the polymeric material to obtain said lens, and
removing the mould.

A method of manufacturing such a device comprises the steps of:
embedding a semiconductor optical element within a housing around said semiconductor optical element, said housing comprising a glass window allowing a light beam to pass through, and
directly replicating a lens on the surface of said glass window outside said housing by means of a replication method as mentioned above.

A corresponding apparatus for manufacturing an integrated semiconductor optical device is defined in claim 4.

The invention is based on the idea of using the replication technology which is a well-known technology for manufacturing high-performance, diffraction-limited lenses. Such a replication method is particularly described in U.S. Pat. No. 4,615,847 the disclosure of which is herein incorporated by reference. Both spheres and flat substrates, usually made of glass, are used as base components, on which a thin layer, in the tens of microns range, of polymer, i.e. the “replica”, is applied. Often, flat substrates are preferred because of costs and convenience.

According to the invention, said replication method is used to replicate a lens on the outer surface of a glass window which is part of the housing. Thus, the flat glass window is used as a substrate for the replication method. By integrating the lens and the semiconductor optical device, the laborious alignment procedure of a discrete lens is not required anymore, and the total device becomes very small and relatively inexpensive.

In a preferred embodiment, the optical element is an optical amplifying crystal, the integrated semiconductor optical device is a semiconductor optical amplifier and the housing comprises an input glass window and an output glass window, on each of which a lens is replicated. However, the invention can be applied to any other semiconductor optical device having one or more glass windows and requiring one or more lenses for coupling in/out a light beam. Such fields of application comprise semiconductor lasers where the laser chip is mounted inside the housing, telecom systems, optical networks, optical amplifiers, tunable laserdiode transmitters, and high-power pump lasers.

The invention will now be explained in more detail with reference to the drawing which shows an embodiment of an integrated semiconductor optical amplifier according to the present invention.

Said semiconductor optical amplifier 1 comprises an amplifying crystal 2, such as an Erlium Doped Fiber Amplifier (EDFA) or a Linear Optical Amplifier (LOA), a housing 3 surrounding said crystal 2 and electrical connections 4. The housing 3 comprises an input glass window 51 allowing an incoming light beam 71 from an input fibre 81 to pass through to the amplifying crystal 2 and an output glass window 52 allowing an amplified light beam 72 to pass through for coupling into an output fibre 82.

Instead of using discrete lenses between the input fibre 81 and the glass window 51 or between the output glass window 52 and the output fibre 82, respectively, coupling lenses 61, 62 are directly replicated on the outer surface of the associated glass window 51, 52 using a replication method. The flat surface of the glass windows 51, 52 thus serves during manufacture as the substrate on which a mould is placed in such a way that a gap remains between the mould and the glass window. Said gap is filled with a liquid light-transmissive polymeric material, such as a lacquer, which is hardened to obtain the lens. Finally the mould is removed. Details of said replication method as well as details of an apparatus for implementing said replication method are described in U.S. Pat. No. 4,615,847 which is herein incorporated by reference.

By using the invention, the optical coupling elements, i.e. the lenses, as well as the semiconductor optical amplifier itself can be integrated, which results in a small and inexpensive device. Furthermore, the alignment procedure of discrete lenses is avoided.

It should be noted that the invention is not limited to a semiconductor optical amplifier as shown in the Figure, but can be applied to any other semiconductor optical device where the housing comprises at least one glass window allowing a light beam to pass through, such as a laser diode.

1. An integrated semiconductor optical device comprising:
an optical element (2),
a housing (3) around said optical element (2),
glass window (51, 52) in said housing (3) allowing a light beam (71, 72) to pass through, and
a lens (61, 62) associated with said glass window (51, 52), said lens (61, 62) being directly replicated on the surface of said glass window (51, 52) outside said housing (3) by means of a replication method comprising the steps of:
filling a gap between the glass window and a mould with a liquid light-transmissive polymeric material,
curing the polymeric material to obtain said lens, and
removing the mould.

2. An integrated semiconductor optical device as claimed in claim 1, wherein said optical element (2) is an optical amplifying crystal, wherein said integrated semiconductor optical device is a semiconductor optical amplifier and wherein said housing (3) comprises an input glass window (51) and an output glass window (52), on each of which a lens (61, 62) is replicated.

3. A method of manufacturing an integrated semiconductor optical device, the method comprising the steps of:
embedding an optical element (2) within a housing (3) around said semiconductor optical element (2), said housing (3) comprising a glass window (51, 52) allowing a light beam (71, 72) to pass through, and
directly replicating a lens (61, 62) on the surface of said glass window (51, 52) outside said housing (3) by means of a replication method comprising the steps of:
filling a gap between the glass window and a mould with a liquid light-transmissive polymeric material,
curing the polymeric material to obtain said lens, and
removing the mould.

4. An apparatus for manufacturing an integrated semiconductor optical device, the apparatus comprising:
means for embedding an optical element (2) beam within a housing (3) around said semiconductor optical element (2), said housing (3) comprising a glass window (51, 52) allowing a light beam to pass through, and
means for directly replicating a lens (61, 62) on the surface of said glass window (51, 52) outside said housing (3) by means of a replication method, said means comprising:
means for filling a gap between the glass window and a mould with a liquid light-transmissive polymeric material,
means for curing the polymeric material to obtain said lens, and
means for removing the mould.
